(19) United States
(12) Patent Application Publication
(10) Pub. No.: US 2020/0228934 A1
(43) Pub. Date: Jul. 16, 2020

(54) LOW LATENCY MULTICAST WIRELESS COMMUNICATION

(71) Applicant: QUALCOMM Incorporated, San DIego, CA (US)

(72) Inventors: Sandip HomChaudhuri, San Jose, CA (US); Jian Tao, Shanghai (CN)

(21) Appl. No.: 16/741,410

(22) Filed: Jan. 13, 2020

Related U.S. Application Data
(60) Provisional application No. 62/793,367, filed on Jan. 16, 2019.

(51) Int. Cl. H04W 4/06; H04W 24/08

(52) U.S. Cl. CPC H04W 4/06; H04L 12/189; H04W 24/08

(57) ABSTRACT

This disclosure provides systems, methods, and apparatus, including computer programs encoded on computer-readable media, for low latency multicast wireless communication. In one aspect, multicast wireless communication may be used in a wireless local area network (WLAN) to distribute audio or video information from an access point to multiple stations. To maintain reliability and low latency, techniques of this disclosure include link training, link adaptation, and blind retries using different transmission rates. In some implementations, a station that detects a link deterioration (such as a loss of data or change in channel quality) can send an unsolicited action frame to the access point. Using the techniques in this disclosure, the access point and the station(s) may maintain the reliability of the multicast wireless communication.

### CROSS-REFERENCE TO RELATED APPLICATIONS

This patent application claims priority to U.S. Provisional Patent Application No. 62/793,367, filed Jan. 16, 2019, entitled “LOW LATENCY MULTICAST WIRELESS COMMUNICATION,” and assigned to the assignee hereof. The disclosure of the prior application is considered part of and is incorporated by reference in this patent application.

### TECHNICAL FIELD

This disclosure relates to the field of network communication, and more particularly to low latency multicast wireless communication in a wireless local area network (WLAN).

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The Institute of Electrical and Electronics Engineers (IEEE) 802.11 family of wireless communication protocol standards (such as that defined by the IEEE 802.11-2016 specification or amendments thereof) defines protocols for wireless communication. The basic building block of a WLAN conforming to the IEEE 802.11 family of standards is a Basic Service Set (BSS), which is managed by an AP and including one or more wirelessly connected STAs associated with the AP. A station (STA) may have a wireless connection (referred to as a wireless association, or just “association”) when it has authenticated and established a wireless session with the AP.

The IEEE 802.11 family of wireless communication protocol standards may offer higher data rates for wireless communication compared to Bluetooth® audio. Transmission efficiency, low latency, and reliability are desirable qualities for some types of content that is communicated via the WLAN. For example, smart media systems (such as wireless speaker systems) may be configured to use a WLAN to communicate audio, video, or multimedia content from a master media output device to one or more slave media output devices. In some examples, the speaker system may include a soundbar (acting as the master media output device) and one or more other remote speakers in an environment which communicate via WLAN. Other types of audio or video systems also may use WLAN to communicate data to distributed endpoints. The WLAN devices may benefit from techniques to optimize throughput or reliability of transmissions on the communication medium.

### SUMMARY

The systems, methods, and devices of this disclosure each have several innovative aspects, no single one of which is solely responsible for the desirable attributes disclosed herein.

One innovative aspect of the subject matter described in this disclosure can be implemented as a method performed by an access point (AP) of a wireless local area network (WLAN). The method may include determining a first transmission data rate for a multicast wireless communication from the access point to a plurality of stations. The first transmission data rate may be based, at least in part, on link training between the access point and each of the plurality of stations. The method may include outputting a first multicast transmission of the multicast wireless communication using the first transmission data rate. The first multicast transmission may include first media content for the plurality of stations.

In some implementations, the first media content may include audio, video, or multimedia content. The transmission data rate may be further based, at least in part, on a latency constraint associated with the first media content.

In some implementations, the access point may be part of a master media output device and the plurality of stations may be part of slave media output devices that are associated with the master media output device.

In some implementations, the master media output device may be a soundbar and the slave media output devices may be remote speakers.

In some implementations, the method may include performing a plurality of initial link trainings between the access point and each of the plurality of stations. The method may include determining a lowest initial link training from among the plurality of initial link trainings. The first transmission data rate may be based, at least in part, on the lowest initial link training.

In some implementations, the method may include performing a periodic link training between the access point and at least one of the plurality of stations. The method may include adapting the first transmission data rate based, at least in part, on the periodic link training.

In some implementations, the periodic link training may be performed for a first station from among the plurality of stations. The first station may have a lowest link training from among a plurality of link trainings associated with the plurality of stations.

In some implementations, the method may include determining a first time period for the first media content based, at least, in part, on a data rate for the first media content. The method may include outputting a second multicast transmission of the first media content using a second transmission data rate different from the first transmission data rate if the second multicast transmission can be transmitted during the first time period.

In some implementations, the method may include determining that the second multicast transmission can be transmitted during the first time period if a duration of the second multicast transmission is less than a time remaining in the first time period after the first multicast transmission.

In some implementations, the method may include outputting a third multicast transmission of the first media content using a third transmission data rate different from the first and second transmission data rates if the third multicast transmission can be transmitted during the first time period.

In some implementations, the second multicast transmission may be a blind retry or retransmission of the first media content.

In some implementations, the second multicast transmission may be a partial retransmission of the first media content.

In some implementations, the second transmission data rate may have a lower data rate than the first transmission data rate.

In some implementations, the first multicast transmission and the second multicast transmission may include a same sequence number associated with the first media content. The sequence number may be usable by the plurality of station to combine or discard duplicate content.

In some implementations, the method may include, after the first time period for the first media content, outputting second media content in further multicast transmissions of the multicast wireless communication. The further multicast transmissions for the second media content may occur during a second time period following the first time period.

In some implementations, the method may include receiving an unsolicited feedback message from a first station of the plurality of stations. The method may include adapting the first transmission data rate in response to receiving the unsolicited feedback message.

In some implementations, adapting the first transmission data rate may include performing a new link training for a link between the access point and at least the first station.

In some implementations, the unsolicited feedback message may include a request for the access point to perform a new link training between the access point and each of the plurality of stations.

In some implementations, the unsolicited feedback message may include a link metric related to a link between the access point and the first station.

In some implementations, the link metric may be based, at least in part, on channel state information (CSI) determined by the first station.

In some implementations, the CSI may be based on at least one member selected from a group consisting of a channel frequency response (CFR), a channel impulse response (CIR), an error vector magnitude (EVM), delay timing, noise floor metric, and decoder confidence levels.

Another innovative aspect of the subject matter described in this disclosure can be implemented as a method performed by a station (STA) of a WLAN. The method may include receiving a first multicast transmission of the multicast wireless communication from an access point. The first multicast transmission may include first media content. The method may include determining a link metric for a link between the access point and the first station. The link metric may be based, at least in part, on the first multicast transmission. The method may include determining whether to send an unsolicited feedback message to the access point based, at least in part, on the link metric and whether the first multicast transmission is successfully received.

In some implementations, the method may include comparing the link metric with a threshold to determine a change in link quality. The method may include sending the unsolicited feedback message from the first station to the access point in response to determining the change in the link quality.

In some implementations, the unsolicited feedback message may include a request for the access point to perform a new link training for the link.

In some implementations, the unsolicited feedback message may include the link metric or an indicator based on the link metric.

In some implementations, the link metric may be based, at least in part, on at least one member selected from a group consisting of channel state information (CSI), a channel frequency response (CFR), a channel impulse response (CIR), an error vector magnitude (EVM), delay timing, noise floor metric, and decoder confidence levels.

In some implementations, the method may include receiving a second multicast transmission of the first media content using a second transmission data rate different from the first transmission data rate.

In some implementations, the second multicast transmission may be a blind retry or retransmission of the first media content.

In some implementations, the first multicast transmission and the second multicast transmission may include a same sequence number associated with the first media content. In some implementations, the method may include combining the first multicast transmission and the second multicast transmission to recover the first media content. In some implementations, the method may include discarding the second multicast transmission if the first multicast transmission was successfully received.

Another innovative aspect of the subject matter described in this disclosure can be implemented as a method performed by an AP. The method may include establishing a wireless association with a plurality of STAs. The method may include performing at least a first link training to determine quality of a wireless channel between the AP and the plurality of STAs. The first link training may include outputting one or more unicast test messages from the AP to the plurality of STAs via the wireless channel, receiving one or more link quality feedback messages from the plurality of STAs in response to the one or more unicast test messages, and determining the quality of the wireless channel based on the one or more link quality feedback messages. The method may include determining a first transmission data rate for a multicast wireless communication from the AP to the plurality of STAs based on the quality of the wireless channel determined by the first link training. The method may include outputting a first multicast transmission of the multicast wireless communication using the first transmission data rate, the first multicast transmission including first media content for the plurality of STAs.

In some implementations, performing the first link training may includes receiving link quality feedback messages from different ones of the plurality of STAs, and determining the quality of the wireless channel based on a lowest link quality indicated from among the link quality feedback messages.

In some implementations, the method may include performing a periodic link training between the AP and at least one of the plurality of STAs to determine a change in the quality of the wireless channel. The method may include adapting the first transmission data rate based on the change in the quality of the wireless channel.

In some implementations, the periodic link training may be performed for a first STA from among the plurality of STAs, the first STA having a lowest link quality indicated during the first link training.

In some implementations, the method may include determining a first time period for the first media content based on a data rate for the first media content. The method may include determining that a second multicast transmission of the first media content can be transmitted during the first time period based on a determination that a duration of the second multicast transmission is less than a time remaining in the first time period after the first multicast transmission. The method may include outputting the second multicast transmission of the first media content during the first time period.

In some implementations, the second multicast transmission is a blind retry or retransmission of the first media content.

In some implementations, the second multicast transmission is a partial retransmission of the first media content.

In some implementations, the first multicast transmission and the second multicast transmission include a same sequence number associated with the first media content, the sequence number usable by the plurality of STAs to combine or discard duplicate content.

In some implementations, the method may include determining that the first time period for the first media content has expired. The method may include outputting second media content in further multicast transmissions of the multicast wireless communication. The further multicast transmissions for the second media content may occur during a second time period following the first time period.

In some implementations, the method may include determining that the second multicast transmission of the first media content can be transmitted using a second transmission data rate different from the first transmission data rate during the first time period. The method may include outputting the second multicast transmission using the second transmission data rate.

In some implementations, the method may include outputting a third multicast transmission of the first media content using a third transmission data rate different from the first and second transmission data rates based on a determination that the third multicast transmission can be transmitted during the first time period.

In some implementations, the method may include receiving an unsolicited feedback message from a first STA of the plurality of STAs. The method may include adapting the first transmission data rate in response to receiving the unsolicited feedback message.

In some implementations, adapting the first transmission data rate may include performing a new link training for a link between the AP and at least the first STA.

In some implementations, the unsolicited feedback message includes a link metric related to a link between the AP and the first STA, the link metric based on the first multicast transmission.

In some implementations, the link metric is based on channel state information (CSI) determined by the first STA based on a channel frequency response (CFR), a channel impulse response (CIR), an error vector magnitude (EVM), delay timing, noise floor metric, or decoder confidence levels.

In some implementations, the first media content includes audio, video, or multimedia content. In some implementations, the first transmission data rate is further based on a latency constraint associated with the first media content.

In some implementations, the AP is part of a master media output device and where the plurality of STAs are part of corresponding slave media output devices that are associated with the master media output device.

Another innovative aspect of the subject matter described in this disclosure can be implemented as a method performed by a STA of a WLAN. The method may include establishing a wireless association with an AP. The method may include participating in at least a first link training between the AP and the first STA. The first link training includes receiving a unicast test message from the AP via a wireless channel, determining a first link metric based on the unicast test message, the first link metric indicative of a quality of the wireless channel, and sending the first link metric in a link quality feedback message to the AP. The method may include receiving a first multicast transmission having first media content from the AP via the wireless channel. The first multicast transmission may have a first data transmission rate that is based on the quality of the wireless channel.

In some implementations, the method may include determining a second link metric for the wireless channel based on the first multicast transmission. The method may include determining to send an unsolicited feedback message to the AP based on a comparison of the second link metric and the first link metric. The method may include sending the unsolicited feedback message from the first STA to the AP in response to a determination that the second link metric has changed beyond a threshold amount compared to the first link metric. The unsolicited feedback message may be configured to cause the AP to perform a new link training.

In some implementations, the unsolicited feedback message may include the second link metric or an indicator based on the comparison of the second link metric to the first link metric.

In some implementations, the method may include receiving a second multicast transmission of the first media content, where the second multicast transmission is a blind retry or retransmission of the first media content. The method may include determining the first media content based on at least one of a) combining the first multicast transmission and the second multicast transmission to recover the first media content, orb) discarding the second multicast transmission if the first multicast transmission was successfully received.

Another innovative aspect of the subject matter described in this disclosure can be implemented as an apparatus. The apparatus may include a processor configured to perform any one of the above-mentioned methods.

Another innovative aspect of the subject matter described in this disclosure can be implemented as a computer-readable medium having stored therein instructions which, when executed by a processor, causes the processor to perform any one of the above-mentioned methods.

Another innovative aspect of the subject matter described in this disclosure can be implemented as a system having means for implementing any one of the above-mentioned methods.

Another innovative aspect of the subject matter described in this disclosure can be implemented as an apparatus in an AP. The apparatus may include an interface configured to establish a wireless association with a plurality of stations (STAs) via a wireless channel. The apparatus may include a processor configured to perform at least a first link training to determine quality of a wireless channel between the AP and the plurality of STAs. The first link training includes the processor being configured to output one or more unicast test messages from the AP to the plurality of STAs via the wireless channel, receive of one or more link quality feedback messages from the plurality of STAs in response to the one or more unicast test messages, and determine the quality of the wireless channel based on the one or more link quality feedback messages. The processor may be configured to determine a first transmission data rate for a multicast wireless communication from the AP to the plurality of STAs based on the quality of the wireless channel determined by the first link training. The processor may be configured to output a first multicast transmission of the multicast wireless communication using the first transmission data rate, the first multicast transmission including first media content for the plurality of STAs.

In some implementations, the processor may be configured to perform a periodic link training between the AP and at least one of the plurality of STAs to determine a change in the quality of the wireless channel. The processor may be configured to adapt the first transmission data rate based on the change in the quality of the wireless channel.

In some implementations, the processor may be configured to determine a first time period for the first media content based on a data rate for the first media content. The processor may be configured to determine that a second multicast transmission of the first media content can be transmitted during the first time period based on a determination that a duration of the second multicast transmission is less than a time remaining in the first time period after the first multicast transmission. The processor may be configured to outputting the second multicast transmission of the first media content during the first time period.

In some implementations, the second multicast transmission is a blind retry or retransmission of the first media content.

In some implementations, the processor is further configured to receive an unsolicited feedback message from a first STA of the plurality of STAs and adapt the first transmission data rate in response to receiving the unsolicited feedback message.

Another innovative aspect of the subject matter described in this disclosure can be implemented as an apparatus in a first station (STA). The apparatus may include an interface configured to establish a wireless association with an AP via a wireless channel. The apparatus may include a processor configured to participate in at least a first link training between the AP and the first STA. The first link training may include the processor being configured to receive a unicast test message from the AP via the wireless channel, determine a first link metric based on the unicast test message, the first link metric indicative of a quality of the wireless channel, and send the first link metric in a link quality feedback message to the AP. The processor may be configured to receive a first multicast transmission having first media content from the AP via the wireless channel. The first multicast transmission may have a first data transmission rate that is based on the quality of the wireless channel.

In some implementations, the processor is further configured to determine a second link metric for the wireless channel based on the first multicast transmission, determine to send an unsolicited feedback message to the AP based on a comparison of the second link metric and the first link metric, and send the unsolicited feedback message from the first STA to the AP in response to a determination that the second link metric has changed beyond a threshold amount compared to the first link metric. The unsolicited feedback message may be configured to cause the AP to perform a new link training.

In some implementations, the unsolicited feedback message includes the second link metric or an indicator based on the comparison of the second link metric to the first link metric.

In some implementations, the processor is further configured to receive a second multicast transmission of the first media content. The second multicast transmission may be a blind retry or retransmission of the first media content. The processor may be configured to determine the first media content based on at least one of a) combining the first multicast transmission and the second multicast transmission to recover the first media content, or b) discarding the second multicast transmission if the first multicast transmission was successfully received.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 depicts a system diagram of an example media system using a wireless local area network (WLAN) to communicate media content.

FIG. 2A depicts a message timing diagram showing an example technique for low latency multicast wireless communication that includes link training.

FIG. 2B depicts a message timing diagram showing an example technique for low latency multicast wireless communication that includes blind retry transmissions.

FIG. 2C depicts a message timing diagram showing an example technique for low latency multicast wireless communication that includes an unsolicited feedback message.

FIG. 2D depicts a message timing diagram showing an example technique for low latency multicast wireless communication that includes aggregated multicast transmissions.

FIG. 3 shows an illustration of example channel state information that may be used to maintain reliable multicast wireless communication.

FIG. 4 depicts a message flow diagram showing examples of low latency multicast wireless communication.

FIG. 5 depicts an depicts an example flowchart for multicast wireless communication with blind retries and unsolicited feedback message.

FIG. 6 depicts a conceptual diagram of an example message for use in multicast maintenance.

FIG. 7 shows a block diagram of an example access point (AP) for use in wireless communication.

FIG. 8 shows a block diagram of an example station (STA) for use in wireless communication.

FIG. 9 depicts an example flowchart for multicast wireless communication by an AP.

FIG. 10 depicts an example flowchart for a STA to maintain link quality for the multicast wireless communication.

FIG. 11 shows a block diagram of an example apparatus for use in a WLAN device according to some implementations.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The examples in this disclosure are based on wireless local area network (WLAN) communication according to the Institute of Electrical and Electronics Engineers (IEEE) 802.11 wireless standards. However, the described implementations may be implemented in any device, system or network that is capable of transmitting and receiving radio frequency (RF) signals according to any wireline or wireless communication standard, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, including systems utilizing 3G, 4G, 5G, 6G, or further implementations thereof, technology.

A WLAN (sometimes also referred to as a Wi-Fi™ network) in a home, apartment, business, or other area may include one or more WLAN devices, including an access point (AP) and one or more stations (STAs) that are associated with the AP. STAs can establish a wireless association (also referred to as a wireless link, wireless connection, or the like) with the AP via a wireless channel. Traditional WLAN implementations may use separate unicast transmissions from the AP to each STA. Unicast transmissions provide confirmed delivery via retries based on a media access control (MAC) layer acknowledgement scheme in which data is retransmitted if an acknowledgement (ACK) is not received. However, due to the limitation of available channel resources and depending on the quantity of stations, unicast communication may not be practical for some types of traffic. Multicast communication can be used by an AP to send media content in a multicast transmission that is concurrently receivable by multiple STAs. Traditional multicast communication may rely on buffering to accommodate transmission delay or jitter. For some types of traffic (such as media content), it may be desirable to support a low latency multicast communication.

Some of the examples in this disclosure are described with reference to a smart media system that implements a WLAN for low latency multicast communication. Smart media systems (also referred to as wireless media systems) are becoming increasingly popular in the industry, for example in consumer electronics. Examples of smart media systems may include a speaker system (for audio output), a video system (for video output), or a multimedia system (for both audio and video output). Although the examples described in this disclosure are based on a smart speaker system, the techniques for low latency multicast wireless communication also may be used by other types of systems that implement a WLAN to communicate low latency traffic. For example, the techniques described with reference to an example smart speaker system may be applied to other types of smart media systems (including video displays or multimedia distribution), voice over internet protocol (VoIP), or conferencing systems, among other examples.

A smart media system may implement a WLAN to communicate low latency media content. In some implementations, a WLAN implementing IEEE 802.11n, IEEE 802.11ac, IEEE 802.11ax, IEEE 802.11be, or later amendments to IEEE 802.11 may operate in the 5 GHz frequency band. The WLAN may offer a higher throughput capability compared to Bluetooth communication links. A master media output device (such as a soundbar) may include an AP to establish a WLAN for one or more slave media output devices (such as remote speakers) that each include a STA interface. In a smart media system having multiple slave media output devices, the transmission of unicast transmissions to each of the slave media output devices may be inefficient. For example, delay associated with contention-based-access, MAC acknowledgements, unicast retransmissions, or interference may result in an unpredictable amount of time available for the AP to communicate unicast transmissions to all the intended slave media output devices. Furthermore, there may be a latency constraint associated with media content used by a smart media system. In an example smart speaker system, a total latency of 25 milliseconds (inclusive of processing at the source and destination hardware) may be desirable. Therefore, some smart media systems may benefit from a technique for low latency multicast wireless communication that supports multiple endpoints. Additionally, high reliability is desired to ensure fidelity of the wireless playback of audio, video, or multimedia content.

This disclosure provides systems, methods, and apparatus, including computer programs encoded on computer-readable media, for low latency multicast wireless communication. Multicast wireless communication may be used in a WLAN to distribute media content from an AP (such as, in a master media output device) to multiple STAs (such as, in corresponding slave media output devices). To maintain reliability and low latency, techniques of this disclosure may enhance multicast wireless communication techniques. For example, multicast communication may include link training, link adaptation, multicast acknowledgments, multicast aggregation, blind retries, and different transmission rates, among other examples. Using the techniques in this disclosure, the AP and the STAs may support low latency multicast communication by enhancing the reliability and utility of traditional multicast wireless communication.

In some implementations, the multicast transmission may be improved based on link training. Link training refers to a process of determining a link quality and transmission data rate via a link between two communication devices. The conditions of the wireless channel may impact a transmission rate or other parameters. Link training enables the communication devices to adapt the transmission data rate based on the conditions of the wireless channel. Link training may include the transmission of one or more test messages and receiving link quality metrics associated with the test messages. The AP may determine a transmission data rate for the multicast transmissions based on the link training between the AP and each of the STAs. For example, the AP may determine a lowest link quality (for the links between the AP and a plurality of STAs) and set the transmission data rate based on the lowest link quality. In some implementations, the transmission data rate may be expressed as a modulation and coding scheme (MCS). For example, the MCS may range from MCS0 (for a low transmission data rate) to MCS9 (for a high transmission data rate). In some implementations, the AP may determine an MCS for the multicast transmission based on a link training procedure such that all the STAs are likely to successfully receive the multicast transmission. The link training procedure may be performed as part of an initial rate adaptation. In some implementations, the link training may be performed periodically to adjust the MCS based on changing conditions of the wireless channel.

In some implementations, reliability of multicast communication may be enhanced using a retransmission scheme. For example, the AP may transmit media content in a first multicast transmission and then retransmit the media content in a subsequent multicast transmission. The retransmission may be used by a receiving STA in case the first multicast transmission is not received by the receiving STA. The retransmission may be referred to as a blind retry retransmission (or similar term) when the retransmission is not based on feedback. In some implementations, the blind retry retransmission may use a different transmission data rate than the previous multicast transmission. For example, a first multicast transmission may use a medium transmission data rate (such as MCS5). A second multicast transmission (of the same media content) may use lower transmission data rates (such as MCS3 or MCS1). There may be a time period available for blind retry retransmissions before the AP proceeds to transmit the next block of media content. Based on the time period and the transmission data rate, the AP may determine how many blind retry retransmissions (and, optionally, the transmission data rate) may be included during the time period. The blind retry retransmissions may include the same sequence number so that a STA can combine the retransmissions or discard duplicate media content.

After an initial link training, the smart media system may be relatively stable or may change over time. As people, animals, or electronics move in the environment, the wireless channel may experience a change in the link quality (such as a degradation due to interference, scattering, or the like). In a traditional multicast communication, there may not be a mechanism for the AP to learn about changes in the link quality. This disclosure includes some techniques for a STA to assist with maintaining the reliability of a multicast communication based on a change in link quality. One or more of the STAs may detect a change in link quality based on the multicast transmissions. There may be various ways for a STA to detect the change. For example, the STA may determine changes in a link metric based on channel state information (CSI), a channel frequency response (CFR), a channel impulse response (CIR), an error vector magnitude (EVM), delay timing, noise floor metric, decoder confidence levels, or other measurable indicator of link quality. This disclosure includes several example link metrics that may be used to detect a change in the link quality. By comparing the link metric to a previous measurement or a threshold, the STA may detect the change in the link quality. In some implementations, if the STA determines a change in the link quality, the STA may send a message (such as an unsolicited feedback message or action frame) to the AP to indicate the change in link quality. In some implementations, the unsolicited feedback message may request the AP to perform a new link training, to retransmit a multicast message, to adapt the transmission data rate, or to begin sending blind retry retransmissions for future multicast transmissions.

In some implementations, a STA that detects a link deterioration (such as a loss of data or change in channel quality) can send an unsolicited feedback message to the AP. Alternatively, or additionally, a STA may send an unsolicited feedback message if the STA fails to decode the multicast transmission. Traditional multicast communication (particularly in IEEE 802.11n and 802.11ac) does not define a mechanism for feedback (acknowledgement or negative acknowledgement) from STAs to indicate whether the multicast communication has been successfully received. Therefore, absent the techniques in this disclosure, an AP may be unaware if the multicast transmissions are received by the STAs. In accordance with some implementations of this disclosure, if the STA detects errors (such as cyclic redundancy check (CRC) errors, physical (PHY) layer, or media access control (MAC) layer errors), the STA may send an unsolicited feedback message to request a retransmission. The unsolicited feedback message may be different from a traditional acknowledgement message; and may be implemented as an action frame that typically would not be used with multicast communication.

In some implementations, an AP (such as in a master media output device of a wireless smart speaker system) may aggregate encoded audio samples and send them off to STAs implemented in a system of corresponding slave speakers. In some implementations, the STAs (such as in slave media output devices) may be grouped such that there may be one or more groups of STAs in the smart media system. Each STA in a group may share a multicast address that is different from the multicast address of a different group of STAs. Using the example of a smart speaker system with nine slave speakers, there may be three groups of slave speakers, each group having three speakers. The AP may prepare a different multicast frame for transmission to each group (represented by a different multicast address). In some implementations, the AP may aggregate the multicast frames into an aggregated transmission. Thus, the AP may send multicast content to each group of STAs while maintaining a low latency for transmissions to the STAs.

Particular implementations of the subject matter described in this disclosure can be implemented to realize one or more of the following potential advantages. A smart media system (such as a wireless speaker system) may use low latency multicast wireless communication to transmit media content from a master media output device to multiple slave media output devices. Even though multicast may not traditionally have sufficient reliability for some applications, the techniques in this disclosure may improve reliability and operation of multicast wireless communication in a WLAN. When applied to a smart media system that includes slave media output devices communicatively connected to an AP via a WLAN, the techniques in this disclosure may enable synchronized output of media by the slave media output devices.

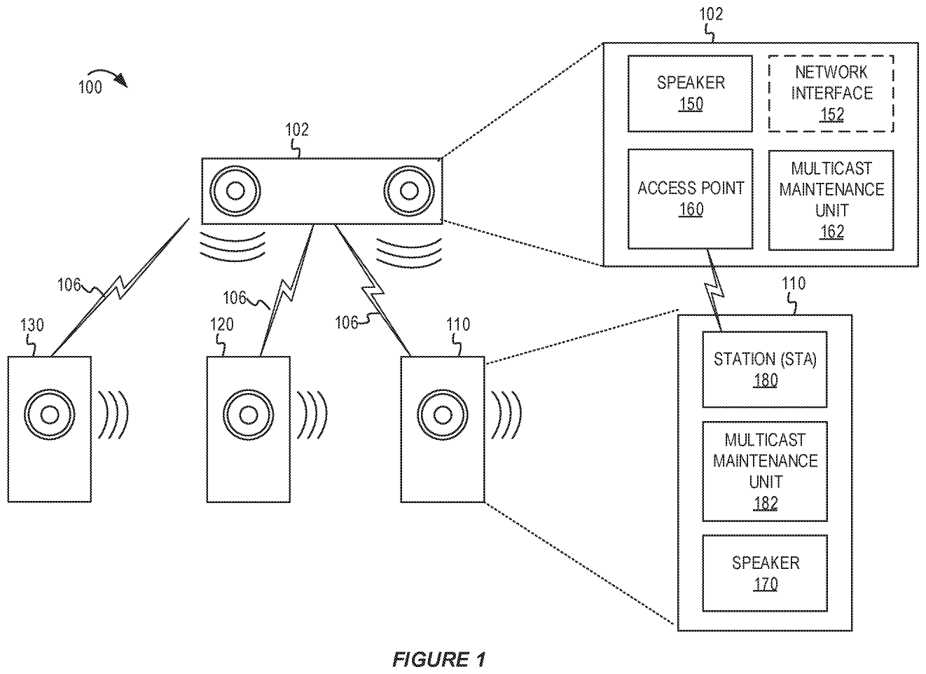

FIG. 1 depicts a system diagram of an example media system using a wireless local area network (WLAN) to communicate media content. FIG. 1 includes a block diagram of an example smart media system that implements a wireless communication network 100. According to some aspects, the wireless communication network 100 can be an example of a WLAN such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof). The smart media system includes a master media output device 102 (such as a sound bar of a wireless speaker system). The smart media system also includes multiple slave media output devices 110, 120, and 130. The master media output device 102 may communicate with the slave media output devices 110, 120, and 130 using wireless communication links 106. For example, the wireless communication link may be established between an access point 160 in the master media output device 102 and a STA 180 in the slave media output device 110.

A WLAN may include numerous wireless communication devices such as the AP 160 and the STAs 160 (in each of the slave media output devices 110, 120, and 130). The AP may utilize a portion of a frequency band (such as a 2.4 GHz frequency band, a 5 GHz frequency band, etc.) as a communication medium. Within each frequency band, there may be different channels which an AP may utilize as the communication medium. Furthermore, the AP may utilize more than one antenna. For example, an AP may utilize multiple-input-multiple-output (MIMO) communication in which multiple antennas transmit wireless signals. The basic building block of a WLAN conforming to the IEEE 802.11 family of standards is a Basic Service Set (BSS), which is managed by an AP. A BSS refers to one STA (such as an AP) that has established service settings and one or more STAs that have successfully synchronized the service settings. Alternatively, a BSS may describe a set of STAs have synchronized matching mesh service profiles. Using the example architecture in FIG. 1, the AP 160 and the associated STAs 180 may be referred to as a basic service set (BSS), which is managed by the AP 160. The BSS may be identified by a service set identifier (SSID) that is advertised by the AP 160. The AP 160 may periodically broadcast beacon frames (“beacons”) to enable any STAs 180 within wireless range of the AP 160 to establish or maintain a respective communication link 106 (also referred to as a “Wi-Fi link” or “wireless association”) with the AP. An “unassociated STA” (not shown) may not be considered part of the BSS because they do not have a wireless session established at the AP 160. To establish a communication link 106 with an AP 160, each of the STAs is configured to perform passive or active scanning operations (“scans”) on frequency channels in one or more frequency bands (for example, the 2.4 GHz, 5 GHz, 6 GHz or 60 GHz bands). Each STA 180 may be configured to identify or select an AP 160 with which to associate based on the scanning information obtained through the passive or active scans, and to perform authentication and association operations to establish a communication link with the selected AP.

The AP 160 and STAs 180 may function and communicate (via their respective communication links) according to the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). These standards define the WLAN radio and baseband protocols for the PHY and medium access control (MAC) layers. The AP 160 and STAs 180 transmit and receive wireless communications (hereinafter also referred to as “Wi-Fi communications”) to and from one another in the form of physical layer convergence protocol (PLCP) protocol data units (PPDUs). The AP 160 and STAs 180 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the AP 160 and STAs 180 described herein also may communicate in other frequency bands, such as the 6 GHz band, which may support both licensed and unlicensed communications. The AP 160 and STAs 180 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 and 5 GHz bands, each of which is divided into multiple 20 MHz channels. As such, these PPDUs are transmitted over a physical channel having a minimum bandwidth of 20 MHz. But larger channels can be formed through channel bonding. For example, PPDUs conforming to the IEEE 802.11n, 802.11ac, 802.11ax, and 802.11be standard amendments may be transmitted over physical channels having bandwidths of 40 MHz, 80 MHz or 160 MHz by bonding together two or more 20 MHz channels. For example, IEEE 802.11n described the use of 2 channels (for a combined 40 MHz bandwidth) and defined a High Throughput (HT) transmission format. IEEE 802.11ac described the use of 8 channels (for a combined 160 MHz bandwidth) and defined a Very High Throughput (VHT) transmission format.

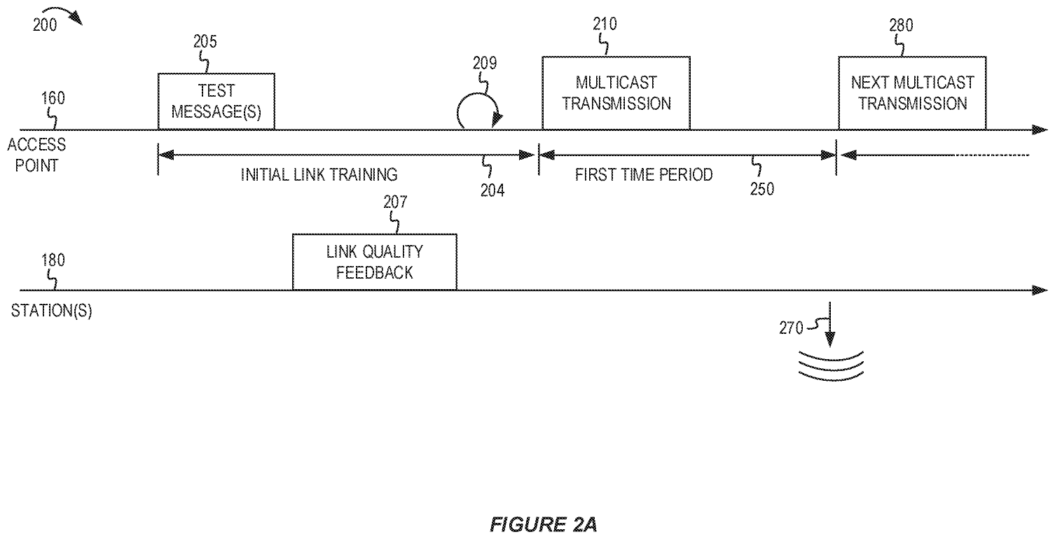

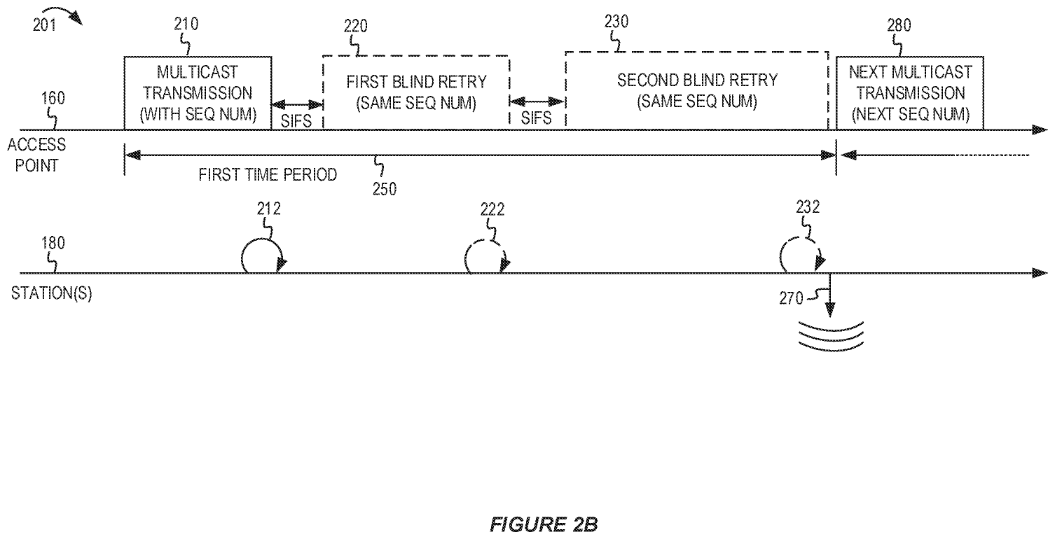

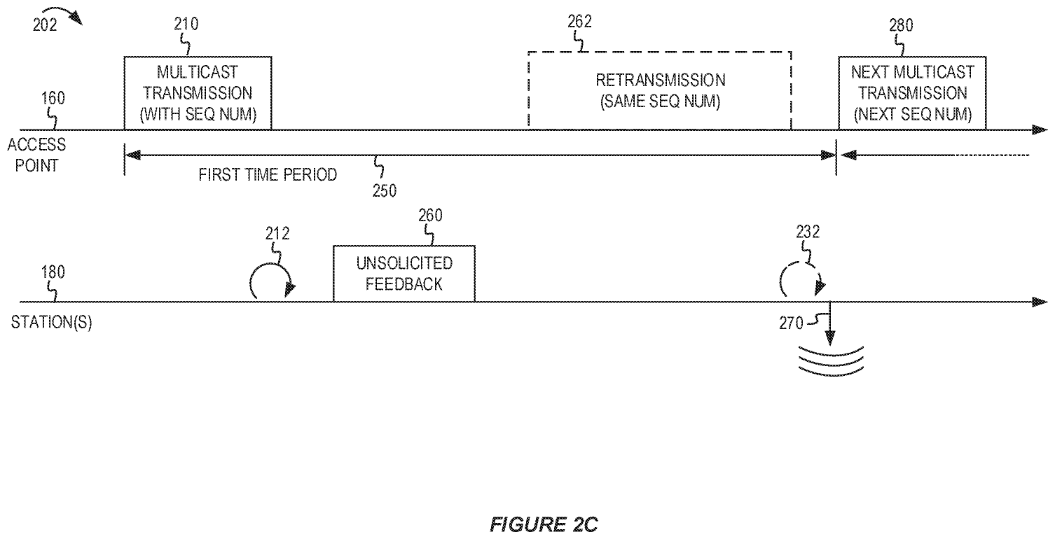

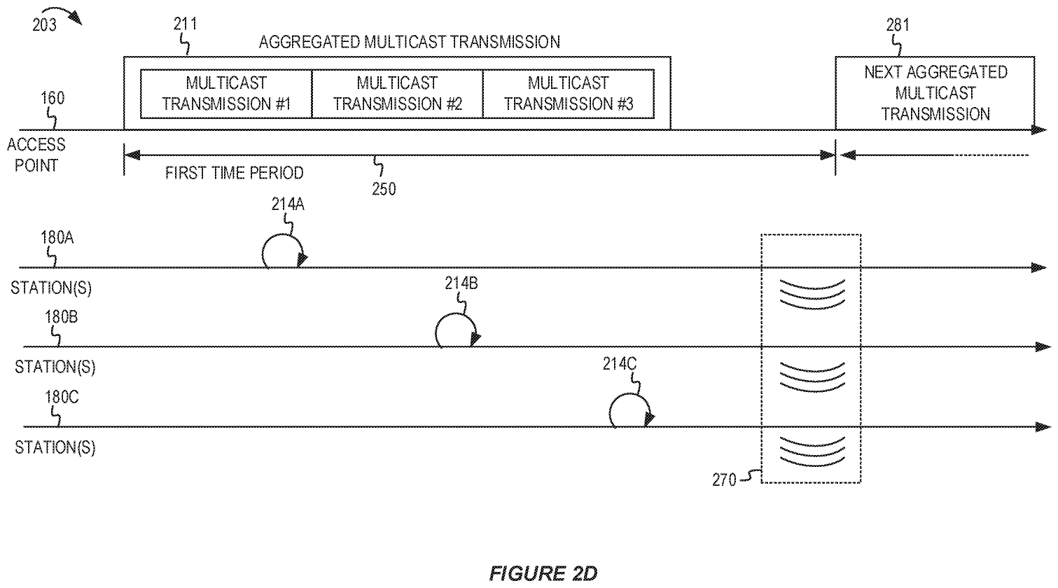

The master media output device 102 may include one or more media outputs (such as speaker 150), the AP 160, as well as a multicast maintenance unit 162. In some implementations, the master media output device 102 also may have a network interface 152 (such as an Ethernet, a second WiFi interface, or other interface) to access a smart home or other network. The master media output device 102 also may have other interfaces (not shown), such as an audio input or output. The AP 160 may establish a BSS on a wireless channel for use by the slave media output devices 110, 120, and 130. Although only three slave media output devices are shown in FIG. 1 for brevity, other smart media systems may have many more slave media output devices. The multicast maintenance unit 162 may perform some of the techniques in this disclosure, such as performing the link training and determining a transmission data rate for the multicast transmissions. These techniques are further described in FIGS. 2A-5.

The first slave media output device 110 is an example of the slave media output devices 110, 120, and 130. The slave media output device 110 may include a STA 180, a multicast maintenance unit 182, and one or more media outputs (such as speaker 170). The multicast maintenance unit 182 may monitor the multicast transmissions and the wireless channel to detect any change in link quality. Furthermore, the multicast maintenance unit 182 may determine if any multicast transmissions are not successfully received. If there is a failure to receive a multicast transmission (or part of a multicast transmission), or if there is a change in the link quality, the multicast maintenance unit 182 may send an unsolicited feedback message to the AP 160. The unsolicited feedback message may request retransmission of a failed multicast transmission. Additionally, or alternatively, the unsolicited feedback message may request the AP to perform a new link training or to adjust the transmission data rate for subsequent multicast transmissions.

In some implementations, a smart media system may specify a certain latency configuration for optimal performance. For example, the latency configuration may specify the overall time budget that includes audio encoding (at source), transmission (from source to slave nodes), other post-processing (with wireless communication in between), and audio playback (at slave nodes) to be less than 25 milliseconds (ms). To accommodate the overall time budget, the time for wireless transmission may be about 1.33 ms. As stated above, the time constraints may not be met with traditional unicast approach. As described above, IEEE 802.11n and IEEE 802.11ac may offer high data rates and the 5 GHz band may offer less congested and rich channel resources. A master wireless soundbar may transmit to up to 9 audio streams to remote speakers. However, by increasing audio codec resolution and support up to 9 audio streams, it would become challenge to use unicast frames for each speaker when audio latency key performance indicator (KPI) is low (such as less than 25 ms). IEEE 802.11 devices use listen-before-talk protocols such that more unicast channel access may result in less efficiency on channel utilization. For example, when one of the speaker fails, that speaker could waste air time on unicast feedback and unicast retransmission packets. A single speaker could potentially starve airtime and negatively impact the remaining speakers.

In some implementations, rather than using unicast delivery of media content, the WLAN may be used for multi-channel/multicast synchronous delivery of media content to multiple remote speakers. In some implementations, a multicast frame may carry audio data for multiple audio streams or content channels using a single PPDU. In some implementations, IEEE 802.11n/ac data rate and low density parity check LDPC) may be used, instead of using legacy 6M/24M (typically reserved for multicast). The appropriate transmission data rate may be chosen for the multicast traffic based on direct or indirect estimation. If the channel condition varies from time to time, the link budget may be revised accordingly to make the multicast transmission data rate more reliable if needed. In some implementations, by operating a 5 GHz dynamic frequency selection (DFS) channel, the WLAN devices may utilize a second radio device (not shown) to implement a zero wait capability, such that the master and slave media output devices may implement power savings when audio is not playing.

FIGS. 2A-2D describe some different options for improving low latency multicast communication in a WLAN. The options are not mutually exclusive, so that the features may be combined in various combinations to define different implementations of low latency multicast communication.

FIG. 2A depicts a message timing diagram showing an example technique for low latency multicast wireless communication that includes link training. The timing diagram 200 shows an AP 160 that communicates with one or more stations in a WLAN. For brevity, the timing diagram 200 only depicts a first STA 180, but there may be a plurality of STAs in the WLAN and they could all belong to the same multicast group or to different multicast groups. Each multicast group may be associated with a different multicast address. The AP 160 may determine a transmission data rate for the low latency multicast communication based on an initial link training procedure 204. For example, the AP 160 may perform link training by sending one or more test messages 205 and receiving link quality feedback 207 from the first STA 180. The AP 160 may determine (shown at process 209) the transmission data rate for a multicast transmission 210. The transmission data rate may be represented as an MCS. By way of example, the MCS for the multicast transmission 210 may be MCS5. In some implementations, the initial link training procedure 204 may include collecting link quality feedback 207 from multiple STAs 180 and selecting the transmission data rate based on the lowest link quality feedback metrics from among the multiple STAs 180. The AP 160 may transmit the multicast transmission 210 using the selected transmission data rate to a plurality of STAs that include the first STA 180. The stations 180 may be incorporated in a slave media output device, such that the slave media output device can output the media content 270 within the time constraint associated with a first time period 250. A next multicast transmission 280 may include further media content. A person having ordinary skill in the art will readily recognize that a series of multicast transmissions (such a as multicast transmissions 210 and 280) can include media content that would form a content stream for output by a media output device.

Returning to the example of a smart speaker system, the initial link training may be implemented to determine a transmission data rate from a master media output device to the slave media output devices. The initial link training may use unicast data to determine the proper transmission data rate before the audio content is transmitted via multicast communication for audio playback. Once the initial link training is done, the master media output device may determine link budgets for all the slave media output devices (such as a probe_rateᵢ, avg_rssiᵢ, select min[probe_rateᵢ], etc.). The most conservative rate and set of parameters may be used as the initial transmission data rate for the master media output device to send multicast communication to the slave media output devices. In some implementations, periodic iterations of the link training procedure (similar to the initial link training procedure 204) may be performed to maintain a healthy and reliable transmission of the multicast media content.

In some implementations, a periodic link training technique may slightly different from the initial link training 204. For example, opportunities may be found to retrain the link budget from the master device to the slave devices using QoS data frames transmitted periodically with MCS rate selection information. In some implementations, a weakest node or static determination technique may be implemented. Since typical soundbar (or soundboard) systems provide an application for setup, some implementations may use the operating system triggered application to characterize the setup and identify which, among the slave nodes, is the weakest slave node. As the soundbar typically does not move, the weakest node may be marked for periodic ACK. Thus, the weakest node (which is one of the slave media output devices in a multicast group) may be used as a representative device to send an acknowledgement on behalf of the multicast group.

FIG. 2B depicts a message timing diagram showing an example technique for low latency multicast wireless communication that includes blind retry transmissions. The timing diagram 201 shows an AP 160 that communicates with one or more stations in a WLAN. Similar to FIG. 2A, the timing diagram 201 only depicts a first STA 180 for brevity. FIG. 2B provides an example in which blind retry transmissions may improve reliability of low latency multicast communication.

A first time period 250 may be based on a latency constraint for the smart media system. For example, the first time period 250 may be 12 ms for audio content having a particular codec and sound quality. During the 12 ms, there may be more time available in the first time period 250 before a next block of audio content needs to be sent in a subsequent time period. The AP 160 may make use of the remaining time in the first time period 250 to send one or more blind retry retransmissions. For example, a first blind retry 220 may be sent following the multicast transmission 210 (after a short interframe space (SIFS)). In some implementations, the first blind retry 220 may have a different (such as a lower) MCS than the multicast transmission 210. Similarly, the AP 160 may transmit a second blind retry 230 using yet another different MCS. The first blind retry 220 and the second blind retry 230 may have a full retransmission of the media content that was included in the multicast transmission 210. Alternatively, the first blind retry 220 or the second blind retry 230 (or both) may have a partial retransmission of the media content. In some implementations, a sequence number included in the multicast transmission 210 and blind retries 220 and 230 may be used to indicate that the packets are redundant transmissions so that the stations 180 will discard duplicate packets that are no longer needed once the media content has been decoded.

The stations 180 may process and attempt to decode (shown as process 212) the block of audio content based on the multicast transmission 210. If unsuccessful, the stations 180 may process 222 the first blind retry 220 and may process 232 the second blind retry 230. If any of the processes 212, 222, or 232 (or a combination of the processing) is successful in decoding the media content, the slave media output device for that STA can output the media content 270 within the time constraint associated with the first time period 250. The low latency multicast communication of media content in transmissions 210, 220, and 230 may repeat for a next block of media content beginning with the next multicast transmission 280 (having the next sequence number).

In some implementations, some techniques may add reliability to the multicast communications. In some implementations, an initial data rate MCSₓ is determined based on min data rate that can guarantee the link for worst slave media output device, but the STA may still miss that packet. In order to attempt to avoid missing the packet, the master media output device may select several rates among {MCSₓ, MCS0} to blindly retry those frames until the audio packet expired in given latency constraint or new audio packet coming. Within a threshold time period (such as the first time period 250), the master media output device may keep retrying the same packet with different and lower MCS marking them with same sequence number, and let the STA 180 remove duplicates. The STA 180 may discard the redundant frames from the AP 160. The available airtime between blocks of media content may be used to send a block of media content using increasingly more reliable transmission data rates. For example, if during the initial link training stage, the min suitable rate MCSₓ=MCS5, then the master media output device may use remaining air time budget to select MCS5, MCS3, MCS1, and try to fill the whole transmission time period (such as first time period 250) as given by time constraint of the master media output device.

The transmission of the first blind retry 220 and the second blind retry 230 may be optional. In some implementations, the AP 160 may refrain from transmitting the blind retry retransmissions and instead may use the remaining time in the first time period 250 for additional link training or to provide an opportunity for the STA 180 to send an unsolicited feedback message as described in FIG. 2C.

FIG. 2C depicts a message timing diagram showing an example technique for low latency multicast wireless communication that includes an unsolicited feedback message. The timing diagram 202 shows an AP 160 that communicates with one or more stations in a WLAN. Similar to FIGS. 2A and 2B, the timing diagram 202 only depicts a first STA 180 for brevity. FIG. 2C provides an example in which a station 180 may transmit an unsolicited feedback message in response to a low latency multicast communication. As described above, traditionally multicast communications are not followed by a feedback message from the recipient. However, as shown in FIG. 2C, an unsolicited feedback message 260 may be used to provide feedback regarding a low latency multicast transmission 210.

The STA 180 may receive and process 212 the multicast transmission 210. If the STA 180 cannot decode the multicast transmission 210, the STA 180 may send the unsolicited feedback message 260 to request a specific retransmission of the missing data. In some implementations, the AP 160 may send a unicast retransmission 262 directed to the STA 180 based on the unsolicited feedback message 260. For example, the AP 160 may send a retransmission that includes only the codewords, blocks, segments, or portions of the multicast transmission 210 that are identified in the unsolicited feedback message 260. Alternatively, or additionally, the unsolicited feedback message 260 may include a sequence number associated with the multicast transmission 210. The AP 160 may send a multicast retransmission 262 of the same content using the same sequence number. In some implementations, the STA 180 may be a representative station that provides feedback on behalf of multiple STAs in the WLAN or in a multicast group. For example, the representative station may be the one which has a lowest link quality determined beforehand using a link training (such as described in FIG. 2A). Following the retransmission 262, the slave media output device for that STA 180 may process 232 the retransmission and output the media content 270 within the time constraint associated with the first time period 250.

In some implementations, the unsolicited feedback message 260 may include a selective ACK technique and may be implemented using an action frame. If a receiving STA 180 is not receiving the multicast transmission 210 (or is detecting CRC errors or any other PHY/MAC errors), the receiving STA 180 can explicitly ask the AP 160 for the lost packets. Thus, the unsolicited feedback message 260 may be different from a traditional MAC layer ACK and instead may be implemented as an action frame. In some implementations, the AP 160 may determine to perform a new link training procedure after receiving the unsolicited feedback message 260 (or a threshold quantity of unsolicited feedback messages).

FIG. 2D depicts a message timing diagram showing an example technique for low latency multicast wireless communication that includes aggregated multicast transmissions. The timing diagram 203 shows an AP 160 that communicates with one or more stations in a WLAN. The timing diagram 202 depicts different stations 180A, 180B and 180C. FIG. 2D provides an example in which the AP 160 may aggregate multicast packets for different multicast groups. For example, STA 180A may represent one group of STAs associated with a first multicast address. STA 180B may represent a different group of STAs associated with a second multicast address. STA 180C may represent yet another different group of STAs associated with a third multicast address. When the STAs establish a wireless link to the AP 160, they also may establish a multicast association which determines their membership in a multicast group (the corresponding multicast address). The STAs 180A, 180B and 180C in the WLAN may observe the wireless channel for multicast transmissions that are directed to their respective multicast address. Rather than sending the different multicast transmissions (numbered #1, #2, and #3) as different PPDUs, the AP 160 may aggregate the multicast transmissions #1, #2, and #3 into an aggregated multicast transmission 211. The aggregated multicast transmission 211 may be a same PPDU that include multiple MAC layer protocol data units (MPDUs). Thus, the aggregated multicast transmission 211 may be similar to an aggregated MPDU (AMPDU) concept except that it includes multicast packets.

Upon receiving the aggregated multicast transmission 211, the STA 180A may determine that it is includes a multicast transmission #1 that includes the first multicast address. Therefore, the STA 180A may process 214A the multicast transmission #1. Similarly, the STA 180B may process 214B the multicast transmission #2 that includes the second multicast address and the STA 180C may process 214C the multicast transmission #3 that includes the third multicast address. In some implementations, the multicast transmissions #1, #2, and #3 include media content which is intended for the STAs 180A, 180B and 180C to output 270 based on a time synchronization. For example, the media content in those multicast transmissions may represent different audio streams or content channels that different speakers (corresponding to STAs 180A, 180B and 180C) of a smart speaker system can output concurrently. Following the first time period 205, the AP 160 may send a next aggregated multicast transmission 281 for a next block of media content in the content streams or content channels.

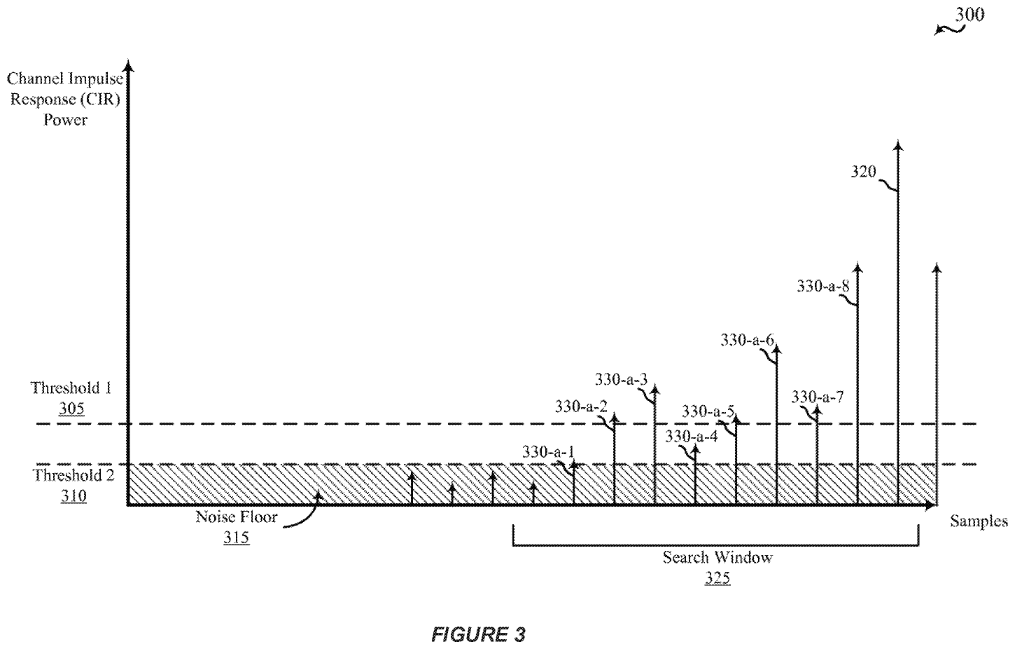

FIG. 3 shows an illustration of example channel state information that may be used to maintain reliable multicast wireless communication. In accordance with some implementations of this disclosure, a STA may help maintain the reliability of the multicast communication by monitoring link quality. For example, the STA may determine a link metric based on a multicast transmission. The link metric may be based on channel state information or other metrics associated with the multicast transmission. For example, the CSI may be compared with a threshold to detect a change in the wireless environment or channel quality that may impact the reliability of the multicast communication. FIG. 3 illustrates an example in which a signal 300 (such as radio signal used to transmit a multicast transmission) may be used to determine the CSI. The signal 300 may be an example of the multicast transmission 210 in FIG. 2. The illustration shows a CIR power for a plurality of received samples. The samples are shown relative to a plurality of thresholds 305 and 310. In some cases, a first threshold 305 (such as threshold 1) is a threshold that is determined relative to the CIR power of the strongest impulse response 320 and remains static independent of channel conditions. For example, threshold 1 may be a baseline for the noise floor 315 of the wireless environment.

The noise floor 315 may be determined in various ways. For example, at least three ways may be used within an IEEE 802.11n/ac deployment. First, a portion of the CIR where channel energy is not expected may be used. In a worst-case scenario, channel power delay profiles (PDPs) may have about 1 microsecond (μs) of span. A CIR capture may span 3.2 μs, which may result in about 2.2 μs worth of noise samples which may be used to determine the noise floor 315. For example, in a system operating at 20 MHz, with a 128 point Fast Fourier Transform (FFT), this may result in 88 noise samples; in a system operating at 40 MHz, with a 256 point FFT, this may result in 176 noise samples; and in a system operating at 80 MHz, with a 512 point Fast Fourier Transform (FFT), this may result in 352 noise samples. Extensions to 160 MHz or higher are obtained in similar manners. Second, tones that do not have a transmit signal may be used as a source of measurement. For example, in a system operating at 20 MHz, there are 64 tones in the frequency domain with an index from −32 to +31. Only tones from −26 to +26 are carrying information. The tones that are outside of +/−26 (where the bandwidth is greater than or equal to 3.75 MHz) are possible candidates for determining the noise floor 315. Third, a receiver error vector magnitude (EVM) may be used to measure the noise floor 315.

An impulse response of a first value, such as the strongest path 320, may be determined, such as by PHY/MAC layers. From the strongest path 320, impulses which precede the strongest path 320 may be searched for CIR impulses which exceed a threshold, such as the second threshold 310. In some cases, only impulses which occur within a search window 325 are searched for CIR impulses. The search window 325 may be determined in various ways. The search window 325 may span the duration of the worst multipath scenario for which the system is designed. For example, the search window may be based at least in part on a number of samples (N) and/or a sample time (T), such as N*T. T may be chosen for various implementations, such as 25 ns for a 20 MHz system, 12.5 ns for a 40 MHz system, 6.25 ns for an 80 MHz system, 3.125 ns for a 160 MHz system, and so on. This assumes a critically sampled system where the sampling frequency is twice the highest bandwidth supported. In some implementations, for systems employing a higher sampling rate, T may be smaller. N may be chosen, such as to fill up a 500 ns delay spread, such as 20 for a 20 MHz system, 40 for a 40 MHz system, 80 for an 80 MHz system, and so on. It should be noted that the above-mentioned values may be specific to various implementations and values may be representative of a typical channel spread as seen in IEEE 802.11n/ac deployments, which often have a guard interval of 800 ns. Other values may be used as appropriate for the specific system desired. However, at the end of the exercise, the relevant spread of the channel can be ascertained and can serve as a qualifying metric of the underlying channel.

A second threshold 310 may indicate a change in the noise floor. For example, a plurality of CIR values 330-a may be found to exceed the second threshold 310 and precede the strongest path 320.

In one scenario, the noise floor 315 may change such that it exceeds the second threshold 310. For example, a change in the noise floor 315 from the second threshold 310 to the first threshold 305 may be indicative of a change in the wireless environment.

After detecting a change in the wireless environment, a STA may send an unsolicited feedback message or action frame to inform the AP of the change. For example, the unsolicited feedback message may include a link metric based on the CIR values, the SNR, or the like. Alternatively, the unsolicited feedback message may simply request the AP to perform a new link training to determine an appropriate transmission data rate for a subsequent multicast transmission.

In some implementations, each STA in the multicast group (or the WLAN) may utilize the CSI from the multicast received data and ascertain a link quality metrics from the CSI (represented via a CFR or CIR sample set). In some implementations, a delay spread, a carrier frequency offset (CFO), or both, may be determined as an estimate of coherence time and bandwidth of the underlying wireless channel. A noise floor from CIR may be determined as an estimate of noise seen on the wireless channel across all CIR taps. Peak CIR and siblings may be determined as indicators of how strong the main communication path is and the spread of its sibling paths. EVM may be determined as a measure of the demodulation error magnitude. Decoder metrics may be determined as a measurement of the Viterbi decoding success or confidence levels. The STA may compare one or more metrics (such as the metrics described above) from the current multicast transmission to the previous running average of previous multicast transmissions to detect for large variations above a threshold. A change in the metric may be indicative of a rapid change in channel conditions. If a STA determines that conditions have changed based on a change in the metric above a threshold, the STA may send an unsolicited feedback message or action frame to cause the AP to perform a new link training as described in this disclosure.

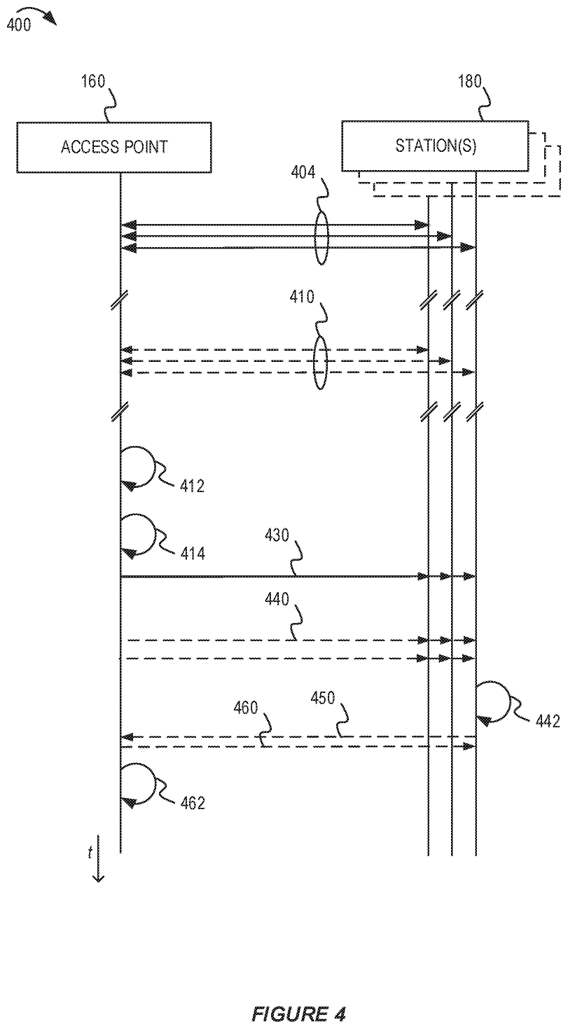

FIG. 4 depicts a message flow diagram 400 showing examples of low latency multicast wireless communication. An AP 160 is communicating with multiple STAs (represented by the STA 180). At 404, the AP 160 may establish a WLAN with the STAs. For example, the WLAN may be a BSS that is created solely for use by smart media system components. At 410, the AP 160 may perform an initial link training to each of the STAs. For example, the AP 160 may send test messages and receive feedback to determine baseline link quality metrics for the WLAN.

At 412, the AP 160 may be triggered to send media content to the STAs. For example, an audio, video, or multimedia application may be launched at a master media output device that initiates transmission of the media content to slave media output devices. At 414, the AP 160 may determine a first transmission data rate for the multicast transmission. At 440, the AP 160 also may send one or more blind retry retransmissions.

At 442, the STA 180 may determine whether or not the multicast transmission was successfully received. If the multicast transmission was not successfully received, the STA 180 may send an unsolicited feedback message 450 to the AP to request retransmission. The AP 160 may retransmit all or part of the media content in a retransmission 460 to the STA 180.

At 462, the AP 160 may adapt the transmission data rate based on the unsolicited feedback message. For example, the AP 160 may determine to use a lower transmission data rate for subsequent multicast transmissions.

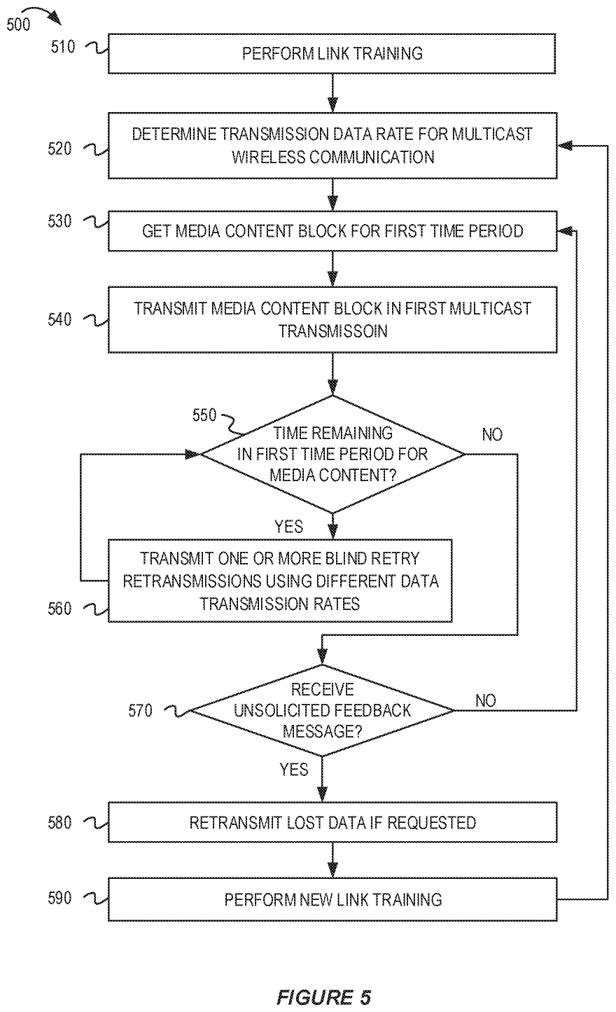

FIG. 5 depicts an example flowchart for multicast wireless communication with blind retries and unsolicited feedback message. The example flowchart 500 begins at block 510. At block 510, the AP may perform link training to determine the link quality between the AP and a plurality of STAs. The link training may be performed as part of an initial link setup, or may be performed periodically, or both. At block 520, the AP may determine a baseline transmission data rate for the multicast communication. At block 530, the AP may get a first media content block associated with a first time period. The first time period may be defined by a latency requirement of the media content. In some cases, the first time period may be sufficient to transmit the same media content block multiple times.

At block 540, the AP may transmit the media content block in a first multicast transmission. At block 550, the AP may determine whether there is time remaining in the first time period for the first media content block to be retransmitted. If so, at block 560, the AP may transmit one or more blind retry retransmissions using different transmission data rates, until there is no time remaining or until a maximum quantity of blind retry retransmissions is reached. If there is not enough time remaining at block 550 or the maximum number of blind retry retransmissions has been reached, the flowchart proceeds to block 570.

At block 570, the AP may determine if it has received an unsolicited feedback message from any of the STAs in the WLAN. If not, the flowchart may return to block 530 where the flowchart continues with a new media content block in a new time period. Alternatively, if an unsolicited feedback message was received, the flowchart continues to block 580. At block 580, the AP may retransmit the lost data if it is indicated in the unsolicited feedback message and if there is enough remaining time in the first time period (also referred to as a time budget) for a retransmission of the previous media content before it exceeds the latency constraint. If the first time period has passed, the AP may proceed to a new media content block and a new time period. However, even if the AP proceeds to a new media content block, the unsolicited feedback message may trigger a reduction in the transmission data rate or a request for link retraining. At block 590, the AP may perform a new link training before returning to block 520. Upon returning to block 520, the AP may determine a new transmission data rate for subsequent multicast transmissions.

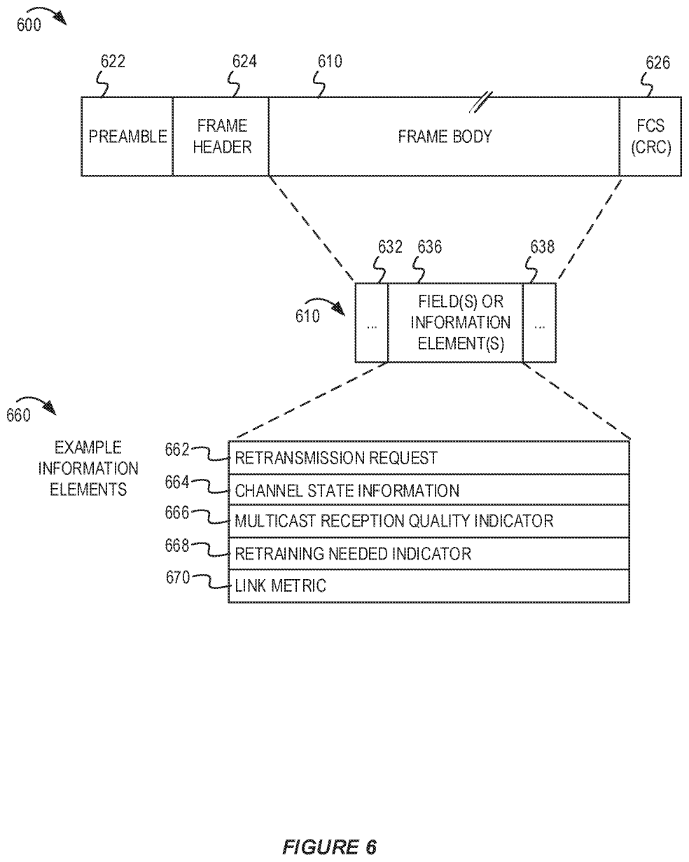

FIG. 6 depicts a conceptual diagram of an example configuration message for use in multicast maintenance. For example, the example message 600 may be sent from a STA to an AP. The example message 600 may include a preamble 622, a header 624, a payload 610, and a frame check sequence (FCS) 626. The preamble 622 may include one or more bits to establish synchronization. The preamble 622 may be used, for example, when a dedicated discovery channel uses a listen-before-talk, contention-based access, or carrier sense access. In some implementations, if the dedicated discovery channel uses a scheduled timeslot for transmission, the preamble 622 may be omitted. The header 624 may include source and destination network addresses (such as the network address of the sending AP and receiving AP, respectively), the length of data frame, or other frame control information. In some implementations, the header 624 also may indicate a technology type associated with a technology-specific payload (if the payload 610 is specific to a particular technology type or types). The payload 610 may be organized with a message format and may include information elements 632, 636, and 638. Several examples of information elements are illustrated in FIG. 6.

Example information elements 660 may be sent as part of an unsolicited feedback message or the like. The example information elements 660 may include a retransmission request 662, a channel state information 664, a multicast reception quality indicator 666, a retraining needed indicator 668, or a link metric 670. For example, the multicast reception quality indicator 666 or the link metric 670 may be based on the CSI or CIR as described in FIG. 3.

Although FIG. 6 describes some examples how a message may communicate regarding an address selection or address change, there may be other example implementations. For example, a wireless communication standard may define the formatting of messages described herein. A message may be formatted to carry different information elements. In some implementations, an existing information element may be modified to include a new field for the unsolicited feedback message.

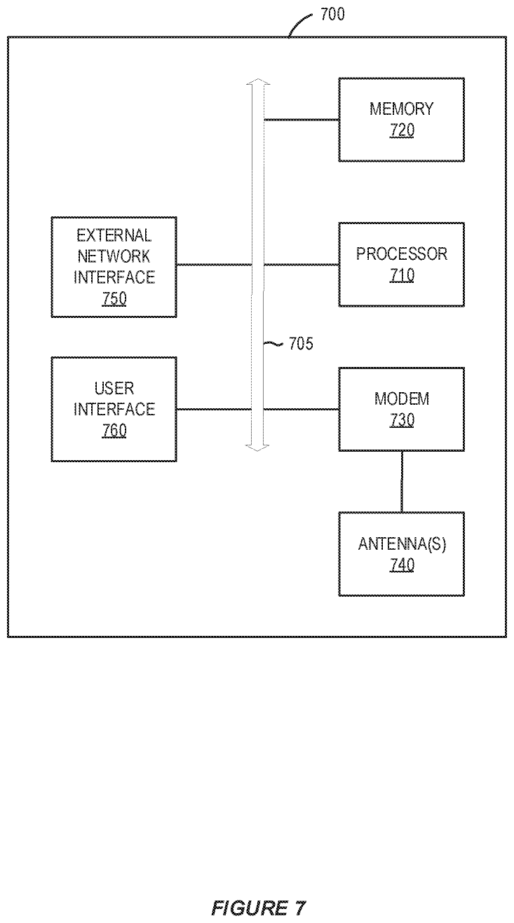

FIG. 7 shows a block diagram of an example AP 700 for use in wireless communication. For example, the AP 700 may be an example of aspects of the AP 160 described with reference to FIG. 1. The AP 700 is capable of transmitting and receiving wireless communications (for example, in the form of wireless packets), as well as of encoding and decoding such communications. For example, the wireless communications can include Wi-Fi packets including frames conforming to an IEEE 802.11 standard. The AP 700 includes at least one processor 710 (collectively “the processor 710”), at least one memory 720 (collectively “the memory 720”), at least one modem 730 (collectively “the modem 730”), at least one antenna 740 (collectively “the antenna 740”), at least one external network interface 750 (collectively “the network interface 750”) and, in some instances, a user interface (UI) 760. Each of the components (or “modules”) described with reference to FIG. 7 can communicate with other ones of the components, directly or indirectly, over at least one bus 705.

The processor 710 can include an intelligent hardware device such as, for example, a central processing unit (CPU), a microcontroller, an application-specific integrated circuit (ASIC), or a programmable logic device (PLD) such as a field programmable gate array (FPGA), among other possibilities. The processor 710 processes information received through the modem 730 and the external network interface 730. The processor 710 also can process information to be sent to the modem 730 for transmission through the antenna 740 and information to be sent to the external network interface 730. The processor 710 can generally be configured to perform various operations related to generating and transmitting a downlink frame and receiving an uplink frame.

The memory 720 can include random access memory (RAM) and read-only memory (ROM). The memory 720 also can store processor- or computer-executable software (SW) code containing instructions that, when executed by the processor 710, cause the processor to perform various functions described herein for wireless communication, including generation and transmission of a downlink frame and reception of an uplink frame.

The modem 730 is generally configured to modulate packets and to provide the modulated packets to the antenna 740 for transmission, as well as to demodulate packets received from the antenna 740 to provide demodulated packets. The modem 730 generally includes or is coupled with at least one radio frequency (RF) transmitter and at least one RF receiver, which may be combined into one or more transceivers, and which are in turn coupled to one or more antennas 740. For example, in some AP implementations, the AP 700 can include multiple transmit antennas (each with a corresponding transmit chain) and multiple receive antennas (each with a corresponding receive chain). The modem 730 can communicate bi-directionally, via the antenna 740, with at least one STA (such as the STA 180 described with reference to FIG. 1).

The modem 730 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 710 for processing, evaluation or interpretation, for example, by one or more host applications executing on the processor.

The AP 700 may communicate with a core or backhaul network through the external network interface 750 to gain access to external networks including the Internet. For example, the external network interface 750 may include one or both of a wired (for example, Ethernet) network interface or wireless (for example, LTE, 4G or 5G) network interface.

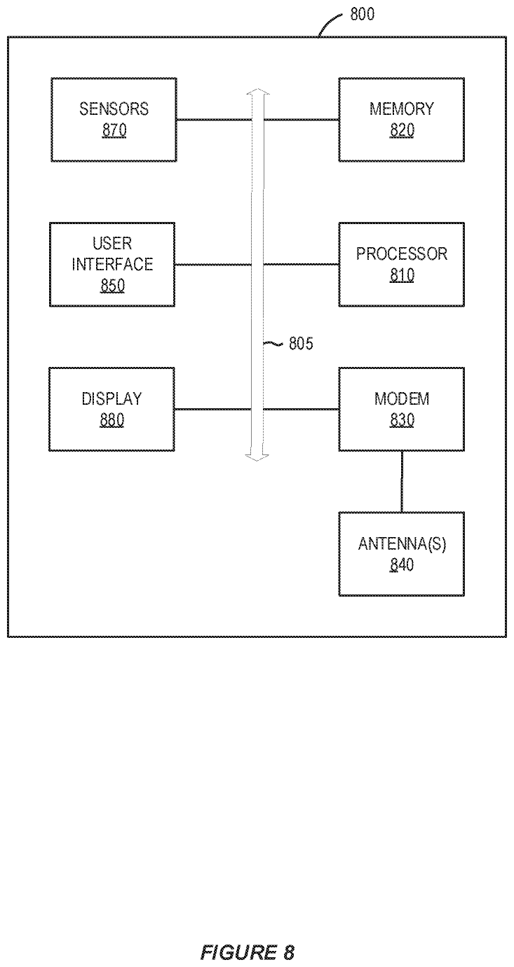

FIG. 8 shows a block diagram of an example STA 800 for use in wireless communication. For example, the STA 800 may be an example of aspects of the STA 180 described with reference to FIG. 1. The STA 800 is capable of transmitting and receiving wireless communications, as well as of encoding and decoding such communications. The wireless communications may conform to any of a number of different wireless communication protocols. For example, the STA 800 may be capable of transmitting and receiving Wi-Fi packets including frames conforming to an IEEE 802.11 standard, such as defined by the IEEE 802.11-2016 specification or amendments thereof including, but not limited to, 802.11ah, 802.11ay, 802.11ax, 802.11az, 802.11ba and 802.11be). Additionally, or alternatively, the STA 800 may be capable of transmitting and receiving Bluetooth packets conforming to a Bluetooth standard, such as defined in IEEE 802.15 or by the Bluetooth SIG. Additionally, or alternatively, the STA 800 may be capable of transmitting and receiving wireless packets associated with the Long Term Evolution (LTE), International Mobile Telecommunications-Advanced (IMT-Advanced) 4G or 5G standards.

The STA 800 includes at least one processor 810 (collectively “the processor 810”), at least one memory 820 (collectively “the memory 820”), at least one modem 830 (collectively “the modem 830”) and at least one antenna 840 (collectively “the antenna 840”). In some implementations, the STA 800 additionally includes some or all of the following: a user interface (UI) 850 (such as a touchscreen or keypad), one or more sensors 870 (such as one or more inertial sensors, accelerometers, temperature sensors, pressure sensors, or altitude sensors), and a display 880. Each of the components (or “modules”) described with reference to Figure I can communicate with one another, directly or indirectly, over at least one bus 805.

The processor 810 includes an intelligent hardware device such as, for example, a CPU, a microcontroller, an ASIC or a PLD such as an FPGA, among other possibilities. The processor 810 processes information received through the modem 830 as well as information to be sent to the modem 830 for transmission through the antenna 840. The processor 810 can be configured to perform various operations related to receiving a downlink frame and generating and transmitting an uplink frame.

The memory 820 can include RAM and ROM. The memory 820 also can store processor- or computer-executable SW code containing instructions that, when executed, cause the processor 810 to perform various functions described herein for wireless communication, including reception of a downlink frame and generation and transmission of an uplink frame.

The modem 830 is generally configured to modulate packets and provide the modulated packets to the antenna 840 for transmission, as well as to demodulate packets received from the antenna 840 to provide demodulated packets. The modem 830 generally includes or is coupled with at least one radio frequency (RF) transmitter and at least one RF receiver, which may be combined into one or more transceivers, and which are in turn coupled to one or more antennas 840. For example, in some implementations, the STA 800 can include multiple transmit antennas (each with a corresponding transmit chain) and multiple receive antennas (each with a corresponding receive chain). The modem 830 can communicate bi-directionally, via the antenna 840, with at least one AP (such as the AP 102 or AP 800 described with reference to FIGS. 1 and 4, respectively). As is described above, in some implementations, the modem also can communicate bi-directionally, via the antenna 840, with other STAs directly without the use of an intermediary AP.

The modem 830 may include digital processing circuitry, automatic gain control (AGC), a demodulator, a decoder and a demultiplexer. The digital signals received from the transceivers are provided to digital signal processing circuitry configured to acquire a received signal, for example, by detecting the presence of the signal and estimating the initial timing and frequency offsets. The digital signal processing circuitry is further configured to digitally condition the digital signals, for example, using channel (narrowband) filtering, analog impairment conditioning, such as correcting for I/Q imbalance, and applying digital gain to ultimately obtain a narrowband signal. The output of the digital signal processing circuitry is fed to the AGC, which is configured to use information extracted from the digital signals, for example, in one or more received training fields, to determine an appropriate gain. The output of the digital signal processing circuitry also is coupled with the demodulator, which is configured to extract modulated symbols from the signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 810 for processing, evaluation or interpretation, for example, by one or more host applications executing on the processor.

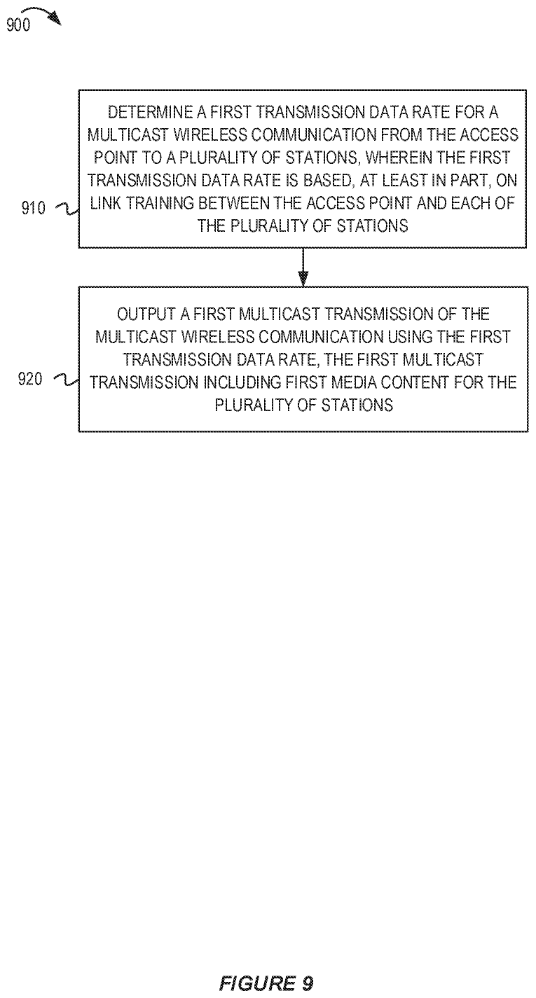

FIG. 9 depicts an example flowchart for multicast wireless communication by an AP. In some implementations, the process 900 may be performed by a first apparatus (such as one of the STAs 180 and 800 described above with reference to FIGS. 1, 2A, 2B, 2C, 2D, 4 and 8, respectively). In some implementations, the process 900 begins in block 910 with determining a first transmission data rate for a multicast wireless communication from the access point to a plurality of stations. The first transmission data rate may be based, at least in part, on link training between the access point and each of the plurality of stations. The process 900 continues in block 920 with outputting a first multicast transmission of the multicast wireless communication using the first transmission data rate. The first multicast transmission may include first media content for the plurality of stations.

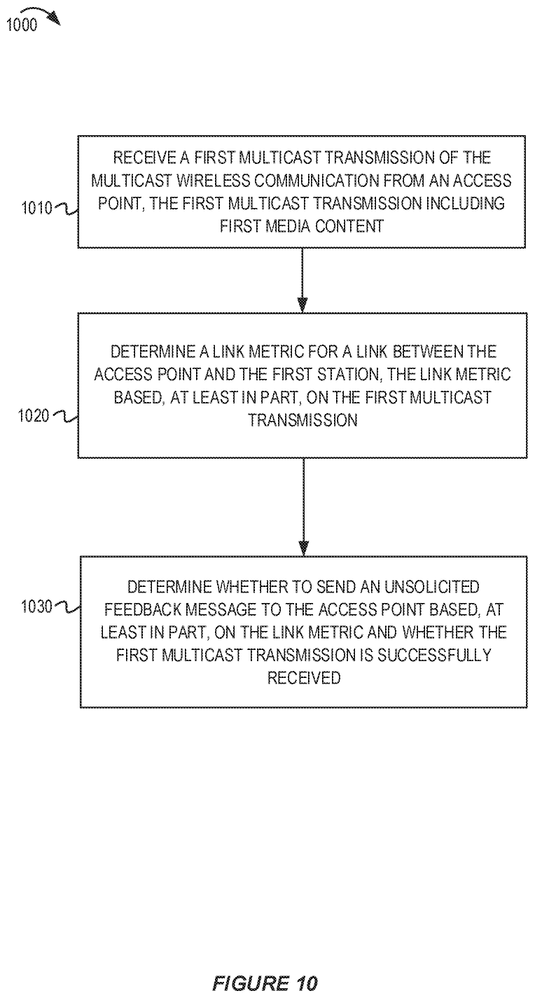

FIG. 10 depicts an example flowchart for a STA to maintain link quality for the multicast wireless communication. In some implementations, the process 1000 may be performed by a first apparatus (such as one of the STAs 180 and 800 described above with reference to FIGS. 1, 2A, 2B, 2C, 2D, 4 and 8, respectively). In some implementations, the process 1000 begins in block 1010 with receiving a first multicast transmission of the multicast wireless communication from an access point. The first multicast transmission may include first media content. The process 1000 continues in block 1020 with determining a link metric for a link between the access point and the first station. The link metric may be based, at least in part, on the first multicast transmission. The process 1000 continues in block 1030 with determining whether to send an unsolicited feedback message to the access point based, at least in part, on the link metric and whether the first multicast transmission is successfully received.

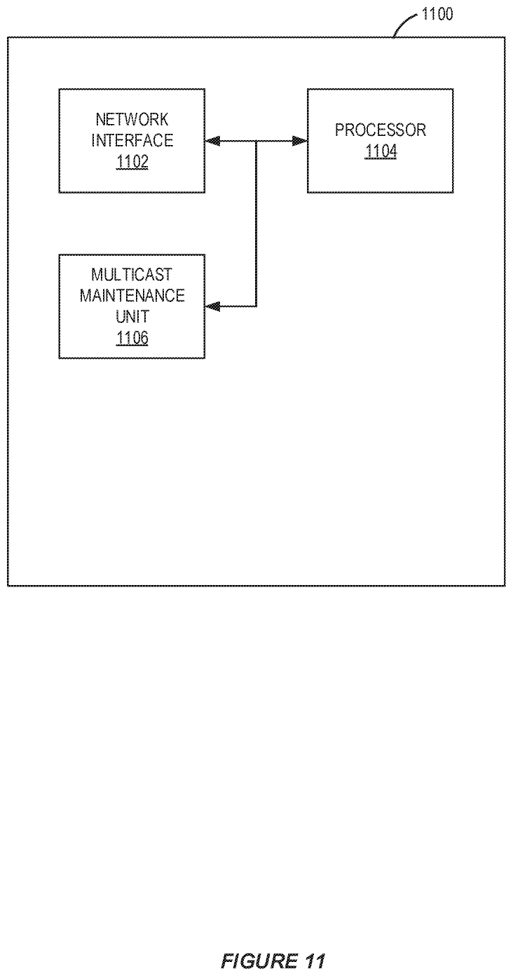

FIG. 11 shows a block diagram of an example apparatus 1100 for use in a WLAN device according to some implementations. In some implementations, the apparatus 1100 can be an example of a module, chip, or component for use in a AP (such as the AP 160 or AP 700 or in a STA (such as the STA 180 or STA 800) as described above with reference to FIGS. 1, 2A, 2B, 2C, 2D, 4, 7, and 8, respectively. In some implementations, the apparatus 1100 is configured to perform one or more of the processes described above with reference to FIGS. 9 and 10, respectively. The apparatus 1100 includes a network interface 1102, a processor 1104, and a multicast maintenance unit 1106. Portions of one or more of the modules 1102, 1104, and 1106 may be implemented at least in part in hardware or firmware. For example, the 1102 may be implemented at least in part by one or more modems (for example, a Wi-Fi (IEEE 802.11) modem). In some implementations, at least some of the modules 1102, 1104, and 1106 are implemented at least in part as software stored in a memory (such as the memory 820). For example, portions of one or more of the modules 1102, 1104, and 1106 can be implemented as non-transitory instructions (or “code”) executable by at least one processor (such as the processor 810) to perform the functions or operations of the respective module.

The network interface 1102 may be configured to transmit or receive multicast messages. The network interface 1102 also may transmit or receive unsolicited feedback messages generated by the multicast maintenance unit 1106.

The processor 1104 may be configured to execute operations of the low latency multicast wireless communication as described in implementations of this disclosure.

The multicast maintenance unit 1106 may be configured to monitor the link quality, adapt transmission rate, or participate in link training. For example, the multicast maintenance unit 1106 may generate an unsolicited feedback message to output to the network interface 1102 when the multicast maintenance unit 1106 determines a change in the link quality of a link between the STA and the AP.

FIGS. 1-11 and the operations described herein are examples meant to aid in understanding example implementations and should not be used to limit the potential implementations or limit the scope of the claims. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray′ disc where disks usually reproduce data magnetically, while discs reproduce data optically with lasers. Combinations also can be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1-32. (canceled)

33. A method for wireless communication by an apparatus of an access point (AP), comprising:
establishing a wireless association with a plurality of stations (STAs);
performing at least a first link training to determine quality of a wireless channel between the AP and the plurality of STAs, wherein the first link training includes:
outputting one or more unicast test messages from the AP to the plurality of STAs via the wireless channel,
receiving one or more link quality feedback messages from the plurality of STAs in response to the one or more unicast test messages, and
determining the quality of the wireless channel based, at least in part, on the one or more link quality feedback messages;
determining a first transmission data rate for a multicast wireless communication from the AP to the plurality of STAs based, at least in part, on the quality of the wireless channel determined by the first link training; and
outputting a first multicast transmission of the multicast wireless communication using the first transmission data rate, the first multicast transmission including first media content for the plurality of STAs.

34. The method of claim 33, wherein performing the first link training includes:
receiving link quality feedback messages from different ones of the plurality of STAs; and
determining the quality of the wireless channel based on a lowest link quality indicated from among the link quality feedback messages.

35. The method of claim 33, further comprising:
performing a periodic link training between the AP and at least one of the plurality of STAs to determine a change in the quality of the wireless channel; and
adapting the first transmission data rate based, at least in part, on the change in the quality of the wireless channel.

36. The method of claim 35, wherein the periodic link training is performed for a first STA from among the plurality of STAs, the first STA having a lowest link quality indicated during the first link training.

37. The method of claim 33, further comprising:
determining a first time period for the first media content based, at least, in part, on a data rate for the first media content;
determining that a second multicast transmission of the first media content can be transmitted during the first time period based on a determination that a duration of the second multicast transmission is less than a time remaining in the first time period after the first multicast transmission; and
outputting the second multicast transmission of the first media content during the first time period.

38. The method of claim 37, wherein the second multicast transmission is a blind retry or retransmission of the first media content.

39. The method of claim 37, wherein the second multicast transmission is a partial retransmission of the first media content.

40. The method of claim 37, wherein the first multicast transmission and the second multicast transmission include a same sequence number associated with the first media content, the sequence number usable by the plurality of STAs to combine or discard duplicate content.

41. The method of claim 37, further comprising:
determining that the first time period for the first media content has expired; and
outputting second media content in further multicast transmissions of the multicast wireless communication, the further multicast transmissions for the second media content occurring during a second time period following the first time period.

42. The method of claim 37, further comprising:
determining that the second multicast transmission of the first media content can be transmitted using a second transmission data rate different from the first transmission data rate during the first time period,
wherein outputting the second multicast transmission includes outputting the second multicast transmission using the second transmission data rate.

43. The method of claim 42, further comprising:
outputting a third multicast transmission of the first media content using a third transmission data rate different from the first and second transmission data rates based on a determination that the third multicast transmission can be transmitted during the first time period.

44. The method of claim 33, further comprising:
receiving an unsolicited feedback message from a first STA of the plurality of STAs; and
adapting the first transmission data rate in response to receiving the unsolicited feedback message.

45. The method of claim 44, wherein adapting the first transmission data rate includes performing a new link training for a link between the AP and at least the first STA.

46. The method of claim 44, wherein the unsolicited feedback message includes a link metric related to a link between the AP and the first STA, the link metric based, at least in part, on the first multicast transmission.

47. The method of claim 46, wherein the link metric is based, at least in part, on channel state information (CSI) determined by the first STA based on at least one member selected from a group consisting of a channel frequency response (CFR), a channel impulse response (CIR), an error vector magnitude (EVM), delay timing, noise floor metric, and decoder confidence levels.

48. The method of claim 33, wherein the first media content includes audio, video, or multimedia content, and wherein the first transmission data rate is further based, at least in part, on a latency constraint associated with the first media content.

49. The method of claim 33, wherein the AP is part of a master media output device and wherein the plurality of STAs are part of corresponding slave media output devices that are associated with the master media output device.

50. A method for multicast wireless communication by an apparatus of a first station (STA), comprising:
establishing a wireless association with an access point (AP);
participating in at least a first link training between the AP and the first STA, wherein the first link training includes:
receiving a unicast test message from the AP via a wireless channel,
determining a first link metric based on the unicast test message, the first link metric indicative of a quality of the wireless channel, and
sending the first link metric in a link quality feedback message to the AP; and
receiving a first multicast transmission having first media content from the AP via the wireless channel, the first multicast transmission having a first data transmission rate that is based, at least in part, on the quality of the wireless channel.

51. The method of claim 50, further comprising:
determining a second link metric for the wireless channel based, at least in part, on the first multicast transmission;
determining to send an unsolicited feedback message to the AP based, at least in part, on a comparison of the second link metric and the first link metric; and
sending the unsolicited feedback message from the first STA to the AP in response to a determination that the second link metric has changed beyond a threshold amount compared to the first link metric, the unsolicited feedback message configured to cause the AP to perform a new link training.

52. The method of claim 51, wherein the unsolicited feedback message includes the second link metric or an indicator based on the comparison of the second link metric to the first link metric.

53. The method of claim 50, further comprising:
receiving a second multicast transmission of the first media content, wherein the second multicast transmission is a blind retry or retransmission of the first media content; and
determining the first media content based on at least one of a) combining the first multicast transmission and the second multicast transmission to recover the first media content, orb) discarding the second multicast transmission if the first multicast transmission was successfully received.

54. An apparatus in an access point (AP), comprising:
an interface configured to establish a wireless association with a plurality of stations (STAs) via a wireless channel; and
a processor configured to:
perform at least a first link training to determine quality of a wireless channel between the AP and the plurality of STAs, wherein the first link training includes the processor configured to:
output one or more unicast test messages from the AP to the plurality of STAs via the wireless channel,
receive of one or more link quality feedback messages from the plurality of STAs in response to the one or more unicast test messages, and
determine the quality of the wireless channel based, at least in part, on the one or more link quality feedback messages;
determine a first transmission data rate for a multicast wireless communication from the AP to the plurality of STAs based, at least in part, on the quality of the wireless channel determined by the first link training; and
output a first multicast transmission of the multicast wireless communication using the first transmission data rate, the first multicast transmission including first media content for the plurality of STAs.

55. The apparatus of claim 54, wherein the processor is further configured to:
perform a periodic link training between the AP and at least one of the plurality of STAs to determine a change in the quality of the wireless channel; and
adapt the first transmission data rate based, at least in part, on the change in the quality of the wireless channel.

56. The apparatus of claim 54, wherein the processor is further configured to:
determine a first time period for the first media content based, at least, in part, on a data rate for the first media content;
determine that a second multicast transmission of the first media content can be transmitted during the first time period based on a determination that a duration of the second multicast transmission is less than a time remaining in the first time period after the first multicast transmission; and
outputting the second multicast transmission of the first media content during the first time period.

57. The apparatus of claim 56, wherein the second multicast transmission is a blind retry or retransmission of the first media content.

58. The apparatus of claim 54, wherein the processor is further configured to:
receive an unsolicited feedback message from a first STA of the plurality of STAs; and
adapt the first transmission data rate in response to receiving the unsolicited feedback message.

59. An apparatus in a first station (STA), comprising:
an interface configured to establish a wireless association with an access point (AP) via a wireless channel; and
a processor configured to:
participate in at least a first link training between the AP and the first STA, wherein the first link training includes the processor being configured to:
receive a unicast test message from the AP via the wireless channel,
determine a first link metric based on the unicast test message, the first link metric indicative of a quality of the wireless channel, and
send the first link metric in a link quality feedback message to the AP; and
receive a first multicast transmission having first media content from the AP via the wireless channel, the first multicast transmission having a first data transmission rate that is based, at least in part, on the quality of the wireless channel.

60. The apparatus of claim 59, wherein the processor is further configured to:
determine a second link metric for the wireless channel based, at least in part, on the first multicast transmission; and
determine to send an unsolicited feedback message to the AP based, at least in part, on a comparison of the second link metric and the first link metric; and
send the unsolicited feedback message from the first STA to the AP in response to a determination that the second link metric has changed beyond a threshold amount compared to the first link metric, the unsolicited feedback message configured to cause the AP to perform a new link training.

61. The apparatus of claim 60, wherein the unsolicited feedback message includes the second link metric or an indicator based on the comparison of the second link metric to the first link metric.

62. The apparatus of claim 59, wherein the processor is further configured to:
receive a second multicast transmission of the first media content, wherein the second multicast transmission is a blind retry or retransmission of the first media content; and
determine the first media content based on at least one of a) combining the first multicast transmission and the second multicast transmission to recover the first media content, orb) discarding the second multicast transmission if the first multicast transmission was successfully received.
